(19) United States
(12) Patent Application Publication
(10) Pub. No.: US 2014/0079952 A1
(43) Pub. Date: Mar. 20, 2014

(54) STRIPPABLE SEMICONDUCTING SHIELD COMPOSITIONS

(71) Applicant: GENERAL CABLE TECHNOLOGIES CORPORATION, Highland Heights, KY (US)

(72) Inventor: Sean W. CULLIGAN, Zionsville, IN (US)

(73) Assignee: GENERAL CABLE TECHNOLOGIES CORPORATION, Highland Heights, KY (US)

(21) Appl. No.: 14/031,705

(22) Filed: Sep. 19, 2013

Related U.S. Application Data
(60) Provisional application No. 61/702,999, filed on Sep. 19, 2012.

(51) Int. Cl. H01B 9/02

(52) U.S. Cl. CPC H01B 9/027
USPC 428/381; 252/509

(57) ABSTRACT

The invention relates to semiconducting shield compositions for electric power cables having a base polymer system, nano-talc, and carbon black. The invention also relates to such semiconducting shield compositions and the use of these semiconducting shield compositions to manufacture semiconductive shields for use in electric cables, electric cables made from these compositions and methods of making electric cables from these semiconducting shield compositions. The semiconducting shield compositions of the invention may be used as strippable “semiconducting” dielectric shields (also referred to as the core shields, dielectric screen and core screen materials) in power cables with cross linked polymeric insulation, primarily with medium voltage cables having a voltage from about 5 kV up to about 100 kV, preferably up to about 35 kV.

This application claims the priority of U.S. Provisional Patent Application No. 61/702,999, filed Sep. 19, 2012, which is incorporated herein by reference.

### FIELD OF THE INVENTION

The invention relates to semiconducting shield compositions for electric power cables having a base polymer system, nano-talc, and carbon black. The invention also relates to such semiconducting shield compositions and the use of these semiconducting shield compositions to manufacture semiconductive shields for use in electric cables, electric cables made from these compositions and methods of making electric cables from those semiconducting shield compositions. The semiconducting shield compositions of the invention may be used as strippable “semiconducting” dielectric shields (also referred to as the core shields, dielectric screen and core screen materials) in power cables with cross-linked polymeric insulation, primarily with medium voltage cables having a voltage from about 5 kV up to about 100 kV, preferably up to about 35 kV.

### BACKGROUND OF THE INVENTION

Typical power cables generally have one or more conductors in a core that is surrounded by several layers that can include: a first polymeric semiconducting shield layer, a polymeric insulating layer, a second polymeric semiconducting shield layer, a metallic tape shield and a polymeric jacket.

In general, semiconducting dielectric shields can be classified into two distinct types, the first type being a type wherein the dielectric shield is securely bonded to the polymeric insulation so that stripping the dielectric shield is only possible by using a cutting tool that removes the dielectric shield along with some of the cable insulation. That type of dielectric shield is preferred by companies that believe that this adhesion minimizes the risk of electric breakdown at the interface of the shield and insulation. The second type of dielectric shield is the “strippable” dielectric shield wherein the dielectric shield has a defined, limited, adhesion to the insulation so that the strippable shield can be peeled cleanly away from the insulation without removing any insulation. Current strippable shield compositions for use over insulation selected from polyethylene, cross-linked polyethylenes, and one of the ethylene copolymer rubbers, such as, ethylene-propylene rubber (EPR) or ethylene-propylene diene terpolymer (EPDM), may be based on an ethylene-vinyl acetate (EVA) copolymer base resin rendered conductive with an appropriate type and amount of carbon black.

Strippable shield formulations of EVA and nitrile rubbers have been described by Ongchin, U.S. Pat. Nos. 4,286,023 and 4,246,142; Burns et al. EP Application No. 0,420,271B, Kakizaki et al U.S. Pat. No. 4,412,938 and Janssun, U.S. Pat. No. 4,226,823, each reference being herein incorporated by reference into this application. A problem with these strippable shield formulations of EVA and nitrile rubber is that the EVA's needed for this formulation have a relatively high vinyl acetate content in order to achieve the desired adhesion level with the result that the formulations are more rubbery than is desired for high speed extrusion of a commercial electric cable.

Alternative adhesion-adjusting additives have also been proposed for use with EVA, for example waxy aliphatic hydrocarbons (Watanabe et al. U.S. Pat. No. 4,933,107, herein incorporated by reference); low-molecular weight polyethylene (Burns Jr., U.S. Pat. No. 4,150,193 herein incorporated by reference); silicone oils, rubbers and block copolymers that are liquid at room temperature (Taniguchi et al. U.S. Pat. No. 4,493,787, herein incorporated by reference); chlorosulfonated polyethylene, ethylene-propylene rubbers, polychloroprene, styrene-butadiene rubber, natural rubber (all in Janssun) but the only one that appears to have found commercial acceptance is paraffin waxes.

U.S. Pat. No. 6,284,374 to Yamazaki, et al discloses a multi-component polymer composition for use in strippable semiconductive shields suitable for a polyolefin-insulated wire and cable crosslinked by silane grafting/water crosslinking. The main polymer component of the composition is mainly composed of an ethylene/vinyl acetate copolymer having a weight average molecular weight not less than 300,000.

U.S. Pat. No. 6,274,066 to Easter discloses a strippable semiconductive shield made from a base polymer and an adhesion modifying additive system where the adhesion between the insulation and the semiconductive shield is between 3-26 pounds per ½ inch.

U.S. Pat. No. 6,972,099 to Easter discloses a strippable semiconductive shield made with a two component base polymer, a hydrocarbon wax or ethylene vinyl acetate (EVA) wax, and carbon black.

It would be desirable to further improve adhesion levels in strippable semiconductive shield compositions, especially for use with insulation layers crosslinked with peroxide based systems.

### SUMMARY OF THE INVENTION

The invention provides remarkably improved adhesion levels in strippable semiconductive shield compositions of less than 6 pounds per ½ inch with insulation layers crosslinked with peroxide based systems. In preferred embodiments of the invention, adhesion levels in strippable semiconductive shield compositions of less than 2 pounds per ½ inch, even about 1 pound per ½ inch, are attained with semiconductive shield compositions in accordance with the invention that are in contact with insulation layers crosslinked with peroxide based systems. Importantly, the compositions of the present invention provide strippable semiconductive shields that meet of exceeds the most current ICEA S-97-682-2001 standards.

The invention provides a semiconductive resin composition for use as a semiconductive layer in contact with a crosslinked wire and cable insulation layer, where the insulation layer is preferably crosslinked using a peroxide cure system. The resin composition contains a base polymer, a nano-talc, and carbon black. “Nano-talc” as used herein means talc having a particle size of below 500 nm, preferably below 250 nm. The base polymer can include ethylene vinyl acetate copolymers, ethylene alkyl acrylate copolymers wherein the alkyl group is selected from C1 to C6 hydrocarbons, ethylene alkyl methacrylate copolymers wherein the alkyl group is selected from C1 to C6 hydrocarbons and ternary copolymers of ethylene with alkyl acrylates and alkyl methacrylates. The base polymer is preferably present at about 48-60%, more preferably about 50-58%, most preferably about 53-55% by weight of the final composition. The nano-talc is preferably present at about 0.5-10%, more preferably about 2-8%, most preferably about 3-6% by weight of the final composition. The carbon black is preferably present at about 30-44%, preferably about 34-40%, most preferably about 36-38% by weight of the final composition.

The invention also provides a method of making a semiconductive resin composition in contact with a crosslinked wire and cable insulation layer, where the insulation layer is preferably crosslinked. The method first includes compounding a base polymer, a nano-talc, and carbon black to form a mixture, which is then extruded to form the semiconductive resin composition, where the semiconductive resin composition is in contact with a crosslinked wire and cable insulation layer and the insulation layer is or has been crosslinked using a peroxide cure system. The base polymer can be as disclosed in the prior paragraph.

The invention also provides a medium voltage electric power cable containing a conductive core, an insulation layer (preferably crosslinked), a strippable semi-conductive shield formed from the semiconductive resin composition of the invention, a grounded metal wire or tape, and a jacket.

### BRIEF DESCRIPTION OF THE DRAWINGS

FIG. 1 is a cross-sectional representation of the electrical cable of the invention; and

FIG. 2 is a perspective view of the electrical cable of the invention.

### DETAILED DESCRIPTION OF THE INVENTION

This invention includes strippable semiconductive shield compositions suitable for use with conventional electrical insulators, shields made from such compositions, electric power cables employing those strippable semiconductive dielectric shields and methods of making both the semiconductive shields and electric power cables employing those shields.

Conventional electrical insulators used in medium voltage cables include polyethylenes, cross-linked polyethylenes (XLPE), ethylene-propylene rubbers and ethylene propylene diene rubbers (EPDM rubbers). The term polyethylene is meant to include both polymers and copolymers wherein ethylene is the major component; that would include, for example, metallocene or single site catalyzed ethylenes that are copolymerized with higher olefins.

The strippable semiconductive shields of the present invention contain a base polymer, a nano-talc, and carbon black. The conductive carbon blacks are added in an amount sufficient to decrease the electrical resistivity to less than 550 ohm-meter. Preferably the resistivity of the semiconductive shield is less than about 250 ohm-meter and even more preferably less than about 100 ohm-meter.

The base polymer is selected from any suitable member of the group consisting of ethylene vinyl acetate copolymers, ethylene alkyl acrylate copolymers wherein the alkyl group is selected from C1 to C6 hydrocarbons, ethylene alkyl methacrylate copolymers wherein the alkyl group is selected from C1 to C6 hydrocarbons and ternary copolymers of ethylene, alkyl acrylates and alkyl methacrylate wherein the alkyl group is independently selected from C1 to C6 hydrocarbons.

The ethylene vinyl acetate copolymer base polymer can be any EVA copolymer with the following properties: the ability to accept high loadings of conductive carbon filler, elongation of 150 to 250 percent and sufficient melt strength to maintain its shape after extrusion. EVA copolymers with vinyl acetate levels above about 25 percent and below about 45 percent having these properties are known. The EVA copolymers can have a vinyl acetate percentage range of about 25 to 45 percent. A preferred EVA copolymer will have a vinyl acetate percentage range of about 28 to 40 percent and an even more preferred EVA copolymer will have a vinyl acetate percentage of about 28 to 33 percent. The EVA copolymers can have a melt flow index (as specified in ASTM D1238 (2013) or ISO 1133 (2011) of about 25-70, preferably about 35-55, more preferably about 40-50. Examples of suitable EVA copolymers would include Elvax® 150, Elvax® 240 and Elvax® 350, sold by DuPont Corp. of Wilmington, Del.

The ethylene alkyl acrylate copolymers can be any suitable ethylene alkyl acrylate copolymers with the following properties: the ability to accept high loadings of conductive carbon filler, elongation of 150 to 250 percent and sufficient melt strength to maintain its shape after extrusion. The alkyl group can be any alkyl group selected from the C1 to C6 hydrocarbons, preferably the C1 to C4 hydrocarbons and even more preferable methyl. Some ethylene alkyl acrylate copolymers with alkyl acrylate levels above about 25 percent and below about 45 percent have these properties. The ethylene alkyl acrylate copolymers can have an alkyl acrylate percentage range of about 25 to 45 percent. A preferred ethylene alkyl acrylate copolymer will have an alkyl acrylate percentage range of about 28 to 40 percent and an even more preferred ethylene alkyl acrylate copolymer will have an alkyl acrylate percentage of about 28 to 33 percent. An example would be Vamac® G or Vamac® HG sold by DuPont Corp. of Wilmington, Del.

The ethylene alkyl methacrylate copolymers can be any suitable ethylene alkyl methacrylate copolymer with the following properties: the ability to accept high loadings of conductive carbon filler, elongation of 150 to 250 percent, and sufficient melt strength to maintain its shape after extrusion. The alkyl group can be any alkyl group selected from the C1 to C6 hydrocarbons, preferably the C1 to C4 hydrocarbons and even more preferable methyl. Some ethylene alkyl methacrylate copolymers with alkyl methacrylate levels above about 25 percent and below about 45 percent have these properties. The ethylene alkyl methacrylate copolymers can have an alkyl methacrylate percentage range of about 25 to 45 percent. A preferred ethylene alkyl methacrylate copolymer will have an alkyl methacrylate percentage range of about 28 to 40 percent and an even more preferred ethylene alkyl methacrylate copolymer will have an alkyl methacrylate percentage of about 28 to 33 percent. An example of a commercially available ethylene methyl methacrylate is Lotryl 35MA05 from Arkema, Inc.

The ternary copolymers of ethylene with alkyl acrylates and alkyl methacrylates can be any suitable ternary copolymer with the following properties: the ability to accept high loadings of conductive carbon filler, elongation of 150 to 250 percent, and sufficient melt strength to maintain its shape after extrusion. The alkyl group can be any alkyl group independently selected from the C1 to C6 hydrocarbons, preferably the C1 to C4 hydrocarbons and even more preferable methyl. Usually a ternary copolymer will be predominantly either an alkyl acrylate with a small portion of an alkyl methacrylate or an alkyl methacrylate with a small portion of an alkyl acrylate. The proportions of alkyl acrylate and alkyl methacrylate to ethylene will be about the same as the proportions described for ethylene alkyl acrylate copolymers or for ethylene alkyl methacrylate copolymers as well as the molecular weight ranges described for ethylene alkyl acrylate and ethylene alkyl methacrylate.

Talc is a naturally occurring mineral, a layered hydrous magnesium silicate of general empirical formula Mg₃Si₄O₁₀(OH)₂, that is broken up and usually ground to a fine powder. Talc is a white, apple green, gray powder with luster pearly or greasy with a Mohs hardness of 1-1.5. It has a high resistance to acids, alkalies and heat. The hydroxy groups normally are internal to the magnesium layer and are not accessible to water except at the edges of the silicate sheet. Thus, conventional talc powder is a hydrophobic material that easily blends and disperses with organic media including polymers but is not easily dispersed in aqueous solvents. The talc powder used in the milling process of the invention may be any commercial talc derived from natural sources. Common talc can be made into nano-talc, for example, by the milling or soaking method of U.S. Pat. No. 7,249,723 to He et al., which is incorporated herein by reference. Importantly, the nano-talc for the present invention has a mean particle size of below 500 nm, preferably below 250 nm. The nano-talc may also be silane treated, which is available. e.g., from Technano, Mumbai, India. Here, the nano-talc is treated with and organosilane, e.g. alkoxysilane, to render an organic coating on the particle surface. The nano-talc is preferably present at about 0.5-10%, more preferably about 2-8%, most preferably about 3-6% by weight of the final composition.

The conductive carbon black can be any conductive carbon blacks in an amount sufficient to decrease the electrical resistivity to less than 550 ohm-meter. Preferably the resistivity of the semiconductive shield is less than about 250 ohm-meter and even more preferably less than about 100 ohm-meter. Suitable carbon blacks include N351 carbon blacks and N550 carbon blacks sold by Cabot Corp. of Boston Mass. The preferred carbon black contains low grit, low ash, and low sulfur. The carbon black is preferably present at about 30-44%, preferably about 34-40%, most preferably about 36-38% by weight of the final composition.

The strippable semiconductive shield formulations of the invention can be compounded by a commercial mixer such as a Banbury mixer, a twin screw extruder a Buss Ko Neader or other continuous mixers. The proportion of the adhesion modifying compound to the other compounds in the strippable semiconductive shield will vary depending on the base polymer, underlying insulation, molecular weight of the adhesion modifying compound and polydispersity of the adhesion modifying compound. A strippable shield formulation can be made by compounding about 30-44 percent, preferably 35percent (by weight of the composition), carbon black with about 0.5-10 percent, preferably 5 percent, nano-talc, and the balance of the base polymer. Optionally any one of, the following components may be added: a) 0.05 to 3.0 percent by weight process aid, b) 0.05 to 3.0 percent by weight antioxidant; and/or c) 0.1 to 3.0 percent by weight cross-linking agent. The strippable shield formulation can be compounded by mixing the carbon black, nano-talc, processing aid, anti-oxidant and the base polymer together in a continuous mixer until well mixed. If a cross-linking agent is to be added it may be added in a second mixing step or absorbed into the polymer mass after mixing. After addition of the cross-linking agent the formulation is ready to be extruded onto the insulation and cross-linked to form the strippable semiconductive shield.

The cross linking agent can be chosen from any of the well know cross-linking agents known in the art including silanes that are cross-linked by moisture and peroxides that form free radicals and cross-link by a free radical mechanism. Non-limiting examples of cross linking agents are dicumyl peroxide; bis(alpha-t-butyl peroxyisopropyl)benzene; isopropylcumyl t-butyl peroxide; t-butylcumylperoxide; di-t-butyl peroxide; 2,5-bis(t-butylperoxy)2,5-dimethylhexane; 2,5-bis(t-butylperoxy)2,5-dimethylhexyne-3; 1,1-bis(t-butylperoxy)3,3,5-trimethylcyclohexane; isopropylcumyl cumylperoxide; di(isopropylcumyl)peroxide; and mixtures thereof. The cross linking agent can be used in amounts of about 0.1 to 5 percent by weight, preferably about 0.1 to 3.0%.

A number of compounds can be used as additives in the semiconducting shield compositions. Typically, those additives fall into the categories of boosters and retardants, scorch retarders, processing aids, pigments, dyes, colorants, fillers, coupling agents, ultraviolet absorbers or stabilizers, antioxidants, antistatic agents, nucleating agents, slip agents, plasticizers, lubricants, viscosity control agents, tackifiers, anti-blocking agents, surfactants, extender oils, and acid scavengers. Unless otherwise indicated below, each additive is preferably used at less than about 2%.

The antioxidant can include, for example, amine-antioxidants, such as 4,4′-dioctyl diphenylamine, N,N′-diphenyl-p-phenylenediamine, and polymers of 2,2,4-trimethyl-1,2-dihydroquinoline; phenolic antioxidants, such as thiodiethylene bis[3-(3,5-di-tert-butyl-4-hydroxyphenyl)propionate], 4,4′-thiobis(2-tert-butyl-5-methylphenol), 2,2′-thiobis(4-methyl-6-tert-butyl-phenol), benzenepropanoic acid, 3,5 bis(1,1 dimethylethyl)4-hydroxy benzenepropanoic acid, 3,5-bis(1,1-dimethylethyl)-4-hydroxy-C13-15 branched and linear alkyl esters, 3,5-di-tert-butyl-4hydroxyhydrocinnamic acid C7-9-Branched alkyl ester, 2,4-dimethyl-6-t-butylphenol Tetrakis{methylene3-(3′,5′-ditert-butyl-4′-hydroxyphenol)propionate}methane or Tetrakis{methylene3-(3′,5′-ditert-butyl-4′-hydrocinnamate}methane, 1,1,3tris(2-methyl-4hydroxyl5butylphenyl)butane, 2,5,di t-amyl hydroqunone, 1,3,5-tri methyl2,4,6tris(3,5di tert butyl4hydroxybenzyl)benzene, 1,3,5tris(3,5di tert butyl4hydroxybenzyl)isocyanurate, 2,2Methylene-bis-(4-methyl-6-tert butyl-phenol), 6,6′-di-tert-butyl-2,2′-thiodi-p-cresol or 2,2′-thiobis(4-methyl-6-tert-butylphenol), 2,2ethylenebis(4,6-di-t-butylphenol), triethyleneglycol bis{3-(3-t-butyl-4-hydroxy-5methylphenyl)propionate}, 1,3,5tris(4tert butyl3hydroxy-2,6-dimethylbenzyl)-1,3,5-triazine-2,4,6-(1H,3H,5H)trione, 2,2methylenebis{6-(1-methylcyclohexyl)-p-cresol}; and/or sulfur antioxidants, such as bis(2-methyl-4-(3-n-alkylthiopropionyloxy)-5-t-butylphenyl)sulfide, 2-mercaptobenzimidazole and its zinc salts, and pentaerythritol-tetrakis(3-lauryl-thiopropionate). The preferred antioxidant is 2,2,4-trimethyl-1,2-dihydroquinoline. Preferably, the antioxidant can be used at about 0.05 to 3.0% by weight of the composition.

The filler, other than nano talc and carbon black, can be, for example, clays, zinc oxide, magnesium oxide, silica, talc, mica, calcium carbonate, wollastonite, and/or zinc borate. The filler can be used at an amount up to about 5% by weight of the total composition.

The processing aid is optionally used to improve processability of the polymer. A processing aid forms a microscopic dispersed phase within the polymer carrier. During processing, the applied shear separates the process aid phase from the carrier polymer phase. The process aid then migrates to the die wall gradually forming a continuous coating layer to reduce the backpressure of the extruder, thereby reducing friction during extrusion. The processing aid is generally a lubricant, such as, but not limited to, stearic acid, silicones, anti-static amines, organic amities, ethanolamides, mono- and di-glyceride fatty amines, ethoxylated fatty amines, fatty acids, zinc stearate, stearic acids, palmitic acids, calcium stearate, zinc sulfate, oligomeric olefin oil, and combinations thereof. Preferably, the processing aid is present at about 0.05 to 3.0% by weight of the composition.

A scorch retarder is a compound that reduces the formation of scorch during extrusion of the composition, at typical extrusion temperatures used, if compared to the same polymer composition extruded without the scorch retarder. Besides scorch retarding properties, the scorch retarder may simultaneously result in further effects like boosting, i.e. enhancing crosslinking performance during the crosslinking step. The scorch retarder can be, but is not limited to, 2,5-bis(1,1-dimethylpropyl)-1,4-benzenediol, 2,4-diphenyl-4-methyl-1-pentene, substituted or unsubstituted diphenylethylene, quinone derivatives, hydroquinone derivatives, monofunctional vinyl containing esters and ethers, or mixtures thereof. The scorch retarder can be used at about 0.25% or less by weight of the total composition.

The polymer compositions of the present invention may be manufactured using conventional machinery and methods to produce the final polymer product. The compositions may be prepared by batch or continuous mixing processes such as those well known in the art. For example, equipment such as Banbury mixers, Buss CoKneaders, and twin screw extruders may be used to mix the ingredients of the formulation. The components of the polymer compositions of the present invention may be mixed and formed into pellets for future use in manufacturing electrical cable.

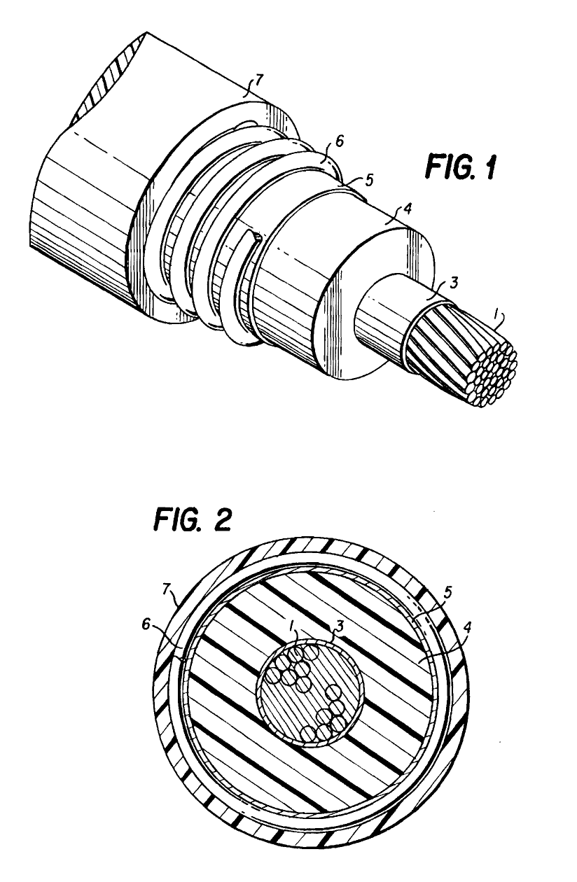

The invention includes electrical cables made using the strippable semiconductive shield of the invention as well as methods of making these electrical cables. As seen in FIGS. 1 and 2, the electrical cable of the invention includes a conductive core (1) surrounded by a semi-conductive layer (3) that is surrounded by an insulating layer (4), the insulation of the insulating layer is selected from polyethylene, cross linked polyethylene (XLPE), ethylene-propylene rubbers and ethylene propylene diene rubbers (EPDM rubbers). The insulating layer (4) is covered by the semiconductive dielectric shield (5) of the invention and the semiconductive shield may be covered by metal wires or strips (6) that are then grounded upon installation of the cable and jacketing (7).

The electrical cable of the invention can be made by any of the methods well known in the art including coating a metal conductor with a semi-conductive layer and in a double extrusion crosshead extruding the insulating layer and the strippable semi-conductive shield together in a simultaneous extrusion or simultaneously extruding a semiconductive layer around a metal conductor, an insulating layer around the semiconductive layer and a strippable semiconductive shield around the insulating layer by using a triple extrusion crosshead. The semiconductive shield, insulating layer and strippable semiconductive shield may then be allowed to internally cross-link if desired. Metal wires or strips are then wrapped around the cable and a jacket is placed over the metal wire or strips to form a finished cable.

Without further description, it is believed that one of ordinary skill in the art can, using the preceding description and the following illustrative examples, make and utilize the compounds of the present invention and practice the claimed methods. The following example is given to illustrate the present invention. It should be understood that the invention is not to be limited to the specific conditions or details described in this example.

### EXAMPLE

All the composition are prepared by using following raw materials:
1. EVA resin: 33% VA-Elvax 150 from DuPont
2. Carbon black: Vulcan XC-200 from Cabot Corp.
3. EVA wax: AC415 from Honeywell
4. Scorch retarder: 2,5-bis(1,1-dimethylpropyl)-1,4-benzenediol-Lowinox AH25 from Chemtura
5. Anti-oxidant: Poly(1,2-dihydro-2,2,4-trimethylquinoline): Naugard Super Q from Chemtura
6. Zinc stearate: from Akrochem
7. t-Butyl cumyl peroxide: Luperox D-16 from Arkema Fillers
8. Talc: Mistron* Vapor R from Luzenac Americas
9.Treated Talc: Mistron* CB-silane treated talc from Luzenac Americas
10. Nano-talc: POS 75 from Technano, India
11. Treated nano-talc-1: POS 75 nanotalc is treated with silane. Silane is oligomeric vinyl silane (Dynasylan* 6598 supplied by Evonik)
12. Treated nano-talc-2: POS 75 nanotalc is treated with silane. Silane is vinyl tris-(2-methoxy ethoxy)silane (Silquest* A-172 supplied by Momentive Performance Materials.
13. Treated nano-talc-3: POS 75 nanotalc is treated with treated with a proprietary long chain amine modifier
14. Treated Nano-mica-1: Nano-mica is treated with silane. Silane is oligomeric vinyl silane (Dynasylan* 6598 supplied by Evonik)
15. Treated Nano-mica-2: Nano-mica is treated with silane. Silane is vinyl tris-(2-methoxy ethoxy)silane (Silquest* A-172 supplied by Momentive Performance Materials.

Semiconductive shield compositions were made using the fillers shown in Table 1. The control has no filler and contains the following:
EVA resin—56.8%
Carbon black—36.9%
EVA wax—4.18%
Scorch retarder—0.05%
Anti-oxidant—0.30%
Zinc stearate—0.69%
t-Butyl cumyl peroxide—1.08%
   Each of the other compositions contains different kinds of filler at approximately 4.8%. All materials (except peroxide) were added to a Banbury-type internal mixer. The rotor speed was 116 RPM and the material was mixed to a temperature of 270 F before the batch was dropped. Peroxide was added in a second pass, with a rotor speed of 77 RPM and a drop temperature of 230 F. The composition s were tested for adhesion (in accordance with the most current UL 1072, ICEA S-75-381, and ICEA T-27-581), tear strength (in accordance with the most current ASTM D470 and D624), volume resistivity (VR) (in accordance with the most current ASTM D257, D991, and D6095), tensile strength (T) (in accordance with the most current ASTM D638), and elongation % (E) (in accordance with the most current ASTM D412). The results are shown in Table 1.

TABLE 1

| | | | Tear | VR @ | |
|---|---|---|---|---|---|
| | | Adhesion | Strength | 105° C. | T, E |
| Example | Filler | (lb/0.5″) | (lbf.) | (Ω-m) | (psi, %) |
| Control | None | 9.5 | 54 | 3.5 | 2000, 215 |
| Example 1 | talc | 6.5 | 45 | 2.5 | 2100, 300 |
| Example 2 | Silane treated | 7.8 | 45 | 4.5 | 2100, 300 |
| | talc | | | | |
| Example 3 | nano-talc | 4.4 | 47 | 3 | 1900, 280 |
| Example 4 | nano-talc + | 3.0 | 45 | 4.0 | 2200, 270 |
| | peroxide blend | | | | |
| Example 5 | Treated Nano- | 8.5 | 40 | 2.5 | 2150, 290 |
| | mica-1 | | | | |
| Example 6 | Treated Nano- | 8.0 | 40 | 2.5 | 2100, 290 |
| | mica-2 | | | | |
| Example 7 | Treated nano- | 4.4 | 36 | 2.3 | 2150, 245 |
| | talc-1 | | | | |
| Example 8 | Treated nano- | 5.2 | 37 | 2.1 | 2130, 290 |
| | talc-2 | | | | |
| Example 9 | Treated nano- | 5.5 | 43 | 2.5 | 2200, 285 |
| | talc-3 | | | | |

While particular embodiments have been chosen to illustrate the invention, it will be understood by those skilled in the art that various changes and modifications can be made therein without departing from the scope of the invention as defined in the appended claims.

What is claimed is:

1. A strippable semiconductive shield composition comprising a base polymer, nano-talc, and carbon black.

2. The composition of claim 1, wherein the base polymer is selected from the group consisting of ethylene vinyl acetate copolymers, ethylene alkyl acrylate copolymers wherein the alkyl group is selected from C1 to C6 hydrocarbons, ethylene alkyl methacrylate copolymers wherein the alkyl group is selected from C1 to C6 hydrocarbons and ternary copolymers of ethylene, alkyl acrylates and alkyl methacrylate wherein the alkyl group is independently selected from C1 to C6 hydrocarbons.

3. The composition of claim 1, wherein the carbon black is sufficient to give the composition a resistance below about to less than 550 ohm-meter.

4. The composition of claim 1, wherein the base polymer is present at about 48% to about 60% by weight of the composition.

5. The composition of claim 1, wherein the nano-talc is present at present at about 0.5% to about 10% by weight of the composition.

6. The composition of claim 1, wherein the carbon black is present at about 30% to about 44% by weight of the composition.

7. The composition of claim 1, further comprising a process aid, an antioxidant, a filler, and/or a cross-linking agent.

8. The composition of claim 7, wherein the processing aid is present at about 0.05 to 3.0% by weight of the composition, the antioxidant is present at about 0.05 to 3.0% by weight of the composition, or the cross-linking agent is present at about 0.1 to 3.0% by weight of the composition.

9. The composition of claim 1, wherein the nano-talc is silane treated.

10. The composition of claim 1, wherein the nano-talc has a mean particle size below about 500 nm.

11. A method for making a strippable semiconductive shield composition comprising the steps of compounding a base polymer with nano-talc and conductive black.

12. The method of claim 11, wherein the base polymer is selected from the group consisting of ethylene vinyl acetate copolymers, ethylene alkyl acrylate copolymers wherein the alkyl group is selected from C1 to C6 hydrocarbons, ethylene alkyl methacrylate copolymers wherein the alkyl group is selected from C1 to C6 hydrocarbons and ternary copolymers of ethylene, alkyl acrylates and alkyl methacrylate wherein the alkyl group is independently selected from C1 to C6 hydrocarbons.

13. The method of claim 11, wherein the carbon black is sufficient to give the composition a resistance below about to less than 550 ohm-meter.

14. The method of claim 11, wherein the base polymer is present at about 48% to about 60% by weight of the composition.

15. The method of claim 11, wherein the nano-talc is present at present at about 0.5% to about 10% by weight of the composition.

16. The method of claim 11, wherein the carbon black is present at about 30% to about 44% by weight of the composition.

17. The composition of claim 11, further comprising a process aid, an antioxidant, a filler, and/or a cross-linking agent.

18. A cable comprising a
conductive core;
an insulating layer;
a strippable semiconductive shield containing a base polymer, nano-talc, and carbon black;
a grounded metal wire of tape; and
a jacket.

19. The cable of claim 18, wherein the base polymer is selected from the group consisting of ethylene vinyl acetate copolymers, ethylene alkyl acrylate copolymers wherein the alkyl group is selected from C1 to C6 hydrocarbons, ethylene alkyl methacrylate copolymers wherein the alkyl group is selected from C1 to C6 hydrocarbons and ternary copolymers of ethylene, alkyl acrylates and alkyl methacrylate wherein the alkyl group is independently selected from C1 to C6 hydrocarbons.

20. The cable of claim 18, wherein the strippable semiconductive shield further containing a process aid, an antioxidant, a filler, and/or a cross-linking agent.
